(19) United States
(12) Patent Application Publication
(10) Pub. No.: US 2016/0030958 A1
(43) Pub. Date: Feb. 4, 2016

(54) A MIST-GENERATING APPARATUS AND METHOD

(71) Applicant: TYCO FIRE & SECURITY GMBH, Neuhausen am Rheinfall (CH)

(72) Inventors: Matthew Charles DYER, Kettering (GB); Jude Alexander Glynn WORTHY, Huntingdon (GB)

(21) Appl. No.: 14/775,975

(22) PCT Filed: Mar. 12, 2014
(86) PCT No.: PCT/EP2014/054898

§ 371 Date: Sep. 14, 2015

(30) Foreign Application Priority Data
Mar. 15, 2013 (GB) 1304713.9

(51) Int. Cl. B05B 7/04; B05B 1/26

(52) U.S. Cl. CPC B05B 7/0416; B05B 1/265

(57) ABSTRACT

A mist generating apparatus is provided, the apparatus comprising a nozzle having a nozzle inlet (54) connectable to a source of driving fluid, a nozzle outlet (58), and a nozzle throat (56) intermediate the nozzle inlet (54) and nozzle outlet (58), the nozzle throat (56) having a cross sectional area which is less than that of both the nozzle inlet (54) and nozzle outlet (58). The apparatus also comprises at least one process fluid passage (32) having an inlet connectable to a source of process fluid and an outlet (34) which opens into the nozzle. A perforated member (46) is located across the process fluid passage outlet (34) to assist the apparatus in atomising the process fluid. Methods of generating a mist and assembling the apparatus are also provided.

The present invention is directed to an apparatus for generating and spraying a mist of droplets into a space or volume. More specifically, the present invention is a twin-fluid mist-generating apparatus which may spray the mist in multiple radial directions about a longitudinal axis of the apparatus.

Twin-fluid atomisers which can spray a mist radially over a 360 angle are known. One such atomiser has a longitudinal axis and comprises first and second opposing surfaces which define a driving fluid nozzle between them. The apparatus also has a process fluid passage having an inlet connectable to a supply of process fluid, and an outlet on one of the first and second surfaces so that process fluid is delivered to the driving fluid nozzle. The driving fluid nozzle has a nozzle inlet connectable to a supply of driving fluid, a nozzle outlet, and a throat portion intermediate the nozzle inlet and nozzle outlet. The nozzle throat has a cross sectional area which is less than that of either the nozzle inlet or the nozzle outlet. The driving fluid nozzle projects radially from the longitudinal axis such that the nozzle defines a rotational angle about the longitudinal axis.

A pressurised driving fluid such as compressed air, steam or nitrogen is supplied to the driving fluid nozzle inlet, and accelerates as it passes through the throat of the nozzle. Consequently, this accelerated driving fluid impinges upon the process fluid (e.g. water) which is entering the nozzle via the process fluid inlet. As the driving and process fluids come into contact with one another an energy transfer takes place, primarily as a result of mass and momentum transfer between the high velocity driving fluid and the relatively low velocity process fluid. This energy transfer imparts a shearing force on the process fluid, leading to the atomisation of the process fluid. This atomisation leads to the formation of a mist made up of a dispersed phase of process fluid droplets in a continuous vapour phase of driving fluid. The mist sprays from the apparatus over a rotational angle relative to the longitudinal axis L, and the rotational angle may be 360 degrees.

The preferred supply pressures of the apparatus, as well as the preferred mass flow ratios between the two fluid supplies, are dependent on the particular application for which the apparatus is to be used. Whilst conventional, fixed decontamination or fire suppression systems in a building or other enclosed space typically receive their decontamination or fire suppression fluid via a supply which is built into the building, twin-fluid mist generators of the type described above also require a dedicated supply of driving fluid. In this type of application the fixed apparatus must therefore also include pressurised supply tanks or canisters holding the driving fluid. Storing, transporting and replacing these canisters is inconvenient and time-consuming. Alternatively such systems may require powerful 3-phase compressors to supply sufficient compressed gas. Such systems require buildings which have a suitable 3-phase electricity supply or the system needs to come with a generator that can supply 3-phase electricity. An on-site 3-phase electricity supply may not be available in smaller commercial, domestic or public spaces such as, for example, shops, doctors surgeries, schools, nursing homes, private residences, commercial and private vehicles, ambulances, and fire engines. Such conventional, fixed decontamination or fire suppression mist generators may be unsuitable in some applications where it may be desirable to spray mist for fire suppression or decontamination into a smaller enclosure. It is also desirable to provide a portable system that can be moved to a desired location and either plugged into the local single phase mains supply, or use smaller compressed gas canisters that can be recharged using a compressor that can be plugged into that local mains supply.

It is an aim of the present invention to obviate or mitigate one or more of the aforementioned disadvantages.

According to a first aspect of the present invention, there is provided a mist generating apparatus, comprising:
a nozzle having a nozzle inlet connectable to a source of driving fluid, a nozzle outlet, and a nozzle throat intermediate the nozzle inlet and nozzle outlet, the nozzle throat having a cross sectional area which is less than that of both the nozzle inlet and nozzle outlet;
at least one process fluid passage having an inlet connectable to a source of process fluid and an outlet which opens into the nozzle; and
a perforated member located across the process fluid passage outlet.

The process fluid passage outlet may open into the nozzle between the nozzle throat and the nozzle outlet.

The nozzle inlet, throat and outlet may be co-axial with a longitudinal axis of the apparatus. The at least one process fluid outlet may open into the nozzle perpendicular, or at an oblique angle, to the longitudinal axis of the apparatus.

The apparatus may further comprise:
a body having a longitudinal axis; and
a driving fluid passage having an inlet connectable to the source of driving fluid and an outlet in fluid communication with the nozzle inlet;
wherein the driving fluid passage and at least one process fluid passage extend longitudinally through the body, and wherein the nozzle extends in a substantially radial direction relative to the longitudinal axis.

The nozzle may extend circumferentially about the body such that the nozzle covers a rotational angle about the longitudinal axis. The rotational angle may be substantially 360 degrees.

A “perforated member” is a member having one or more apertures therein. The perforated member breaks up the process fluid flow into discrete jets or droplets as the process fluid exits the process fluid outlet and passes through the apertures within the perforated member. The aperture(s) may take the form of one or more slots, or one or more holes. The perforated member may comprise a plate located between the or each process fluid passage outlet and the nozzle, the plate having a group of apertures adjacent the or each process fluid passage outlet. Alternatively, the perforated member may comprise a plate located between the process fluid passage outlet and the nozzle, the plate having a plurality of apertures forming a ring around the plate. The apertures may be of uniform size. The apertures may be circular and each have a diameter of about 0.1 mm to 0.5 mm. Most preferably, the apertures are about 0.2 mm in diameter. Alternatively, the perforated member may comprise a plate located between the process fluid passage outlet and the nozzle, the plate having a single aperture forming a ring around the plate. In any event, in order to break up the process fluid flow the aperture(s) within the perforated member must have a total cross sectional area which is less than that of the respective process fluid outlet across which those apertures lie.

The apparatus may further comprise a baffle located in the nozzle, the baffle including one or more sections which close off a portion of the rotational angle covered by the nozzle. The baffle may have three sections, each of which closes off a 90 degree segment of the rotational angle covered by the nozzle.

Each pair of adjacent baffle sections defines a baffle opening therebetween, each baffle opening having a baffle inlet, baffle outlet and baffle throat intermediate the baffle inlet and baffle outlet, wherein the baffle throat has a cross sectional area which is smaller than that of both the baffle inlet and baffle outlet.

The body may comprise a first portion in which the driving fluid passage and one or more process fluid passages are located, and a second portion which can be detachably fixed to the first portion, wherein the perforated member lies upon the first portion and defines a first nozzle surface and the second portion has a second nozzle surface such that when the first and second portions are attached the nozzle is defined between the first and second nozzle surfaces.

The body may have a total height of about 20.1 to 40.5 mm and a diameter of about 25 to 30 mm. Most preferably, the body may have a total height of about 30 mm and a diameter of about 28.6 mm.

According to a second aspect of the invention there is provided a mist generating apparatus, comprising:
a lower body portion including a driving fluid passage having a driving fluid inlet and a driving fluid outlet, and at least one process fluid passage having a process fluid inlet and a process fluid outlet, the driving and process fluid inlets being connectable to respective sources of driving and process fluids;
a first member including a plurality of apertures, the first member lying on top of the lower body portion such that the apertures are located across the process fluid passage outlet;
a second member lying upon the first member and including a plurality of baffle sections which divide the driving fluid outlet into distinct sections; and
an upper body portion which lies upon the second member and is secured to the lower body portion so as to hold the first and second members between the upper and lower body portions;
wherein the first member defines a first nozzle surface and the upper body portion defines a second nozzle surface facing the first nozzle surface, the two nozzle surfaces between them defining at least one nozzle having a nozzle inlet in fluid communication with the driving fluid outlet, a nozzle outlet and a nozzle throat intermediate the nozzle inlet and nozzle outlet, the nozzle throat having a cross sectional area which is less than that of the nozzle inlet and nozzle outlet, and wherein the process fluid outlet opens into the nozzle at or downstream of the nozzle throat.

According to a third aspect of the present invention there is provided a mist generating system, comprising:
a mist generating apparatus in accordance with either the first or second aspect of the invention;
a driving fluid source connected to the nozzle inlet for the supply of driving fluid to the nozzle; and
a process fluid source connected to the process fluid passage inlet for the supply of process fluid to the process fluid passage.

The system may further comprise a compressor located between the driving fluid source and the nozzle inlet. The compressor may be powered by mains electricity.

The system may further comprise a pump located between the process fluid source and the process fluid passage.

According to a fourth aspect of the present invention, there is provided a method of generating a mist, comprising the steps of:
supplying a driving fluid to a nozzle having a nozzle inlet, a nozzle outlet and a nozzle throat intermediate the nozzle inlet and nozzle outlet, the nozzle throat having a cross sectional area which is less than that of both the nozzle inlet and nozzle outlet;
supplying a process fluid to a process fluid outlet which opens into the nozzle;
passing the process fluid through a perforated member located across the process fluid outlet;

accelerating the driving fluid through the nozzle throat such that the driving fluid applies a shearing force to the process fluid jet having passed through the perforated member, thereby forming a dispersed phase of process fluid droplets in a continuous vapour phase of driving fluid; and

spraying the dispersed process fluid droplets and continuous driving fluid phase from the nozzle outlet.

The driving fluid may be compressible. The driving fluid may be selected from the group comprising compressed air, nitrogen or steam.

The driving fluid may be accelerated to sonic or supersonic velocity downstream of the nozzle throat.

The process fluid may be a liquid. The process fluid may be selected from the group comprising water, a liquid fire suppressant, a liquid decontaminant and a liquid disinfectant.

According to a fifth aspect of the invention there is provided a method of assembling a mist generating apparatus, the method comprising the steps of:
providing a lower body portion including a driving fluid passage having a driving fluid inlet and a driving fluid outlet, and at least one process fluid passage having a process fluid inlet and a process fluid outlet, the driving and process fluid inlets being connectable to respective sources of driving and process fluids;
placing a first member including a plurality of apertures on top of the lower body portion such that the apertures are located across the process fluid passage outlet;
placing a second member upon the first member, the second member including a plurality of baffle sections which divide the driving fluid outlet into distinct sections; and
placing an upper body portion upon the second member and securing the upper body member to the lower body portion so as to hold the first and second members between the upper and lower body portions;
wherein the first member defines a first nozzle surface and the upper body portion defines a second nozzle surface facing the first nozzle surface, and the two nozzle surfaces between them define at least one nozzle having a nozzle inlet in fluid communication with the driving fluid outlet, a nozzle outlet and a nozzle throat intermediate the nozzle inlet and nozzle outlet, the nozzle throat having a cross sectional area which is less than that of the nozzle inlet and nozzle outlet, and wherein the process fluid outlet opens into the nozzle at or downstream of the nozzle throat.

A preferred embodiment of the present invention will now be described, by way of example only, with reference to the accompanying drawings in which:

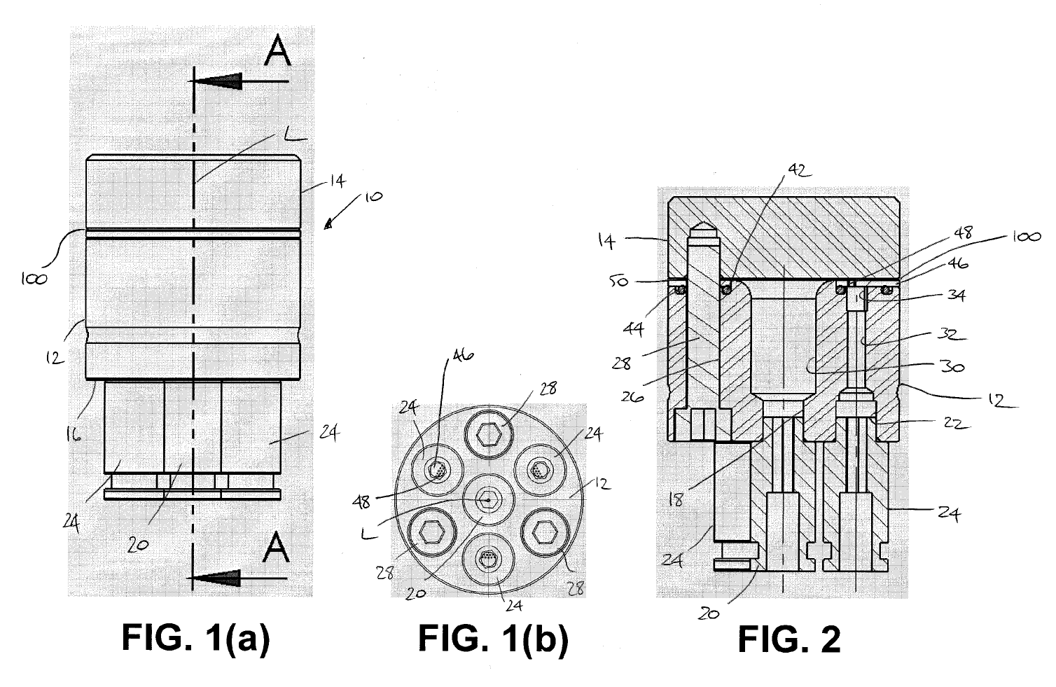

FIGS. 1(a) and 1(b) are side and bottom views, respectively, of a mist generating apparatus;

FIG. 2 is a section view through the apparatus along the line A-A shown in

FIG. 1(a);

FIGS. 3-6 are perspective views of the apparatus of FIGS. 1 and 2 at various stages in its assembly process;

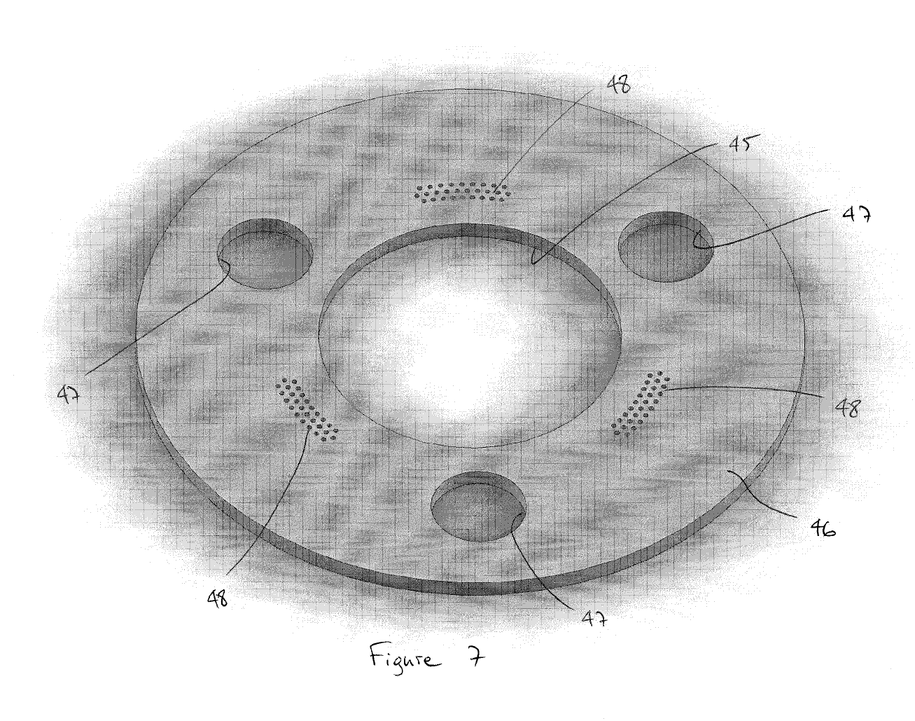

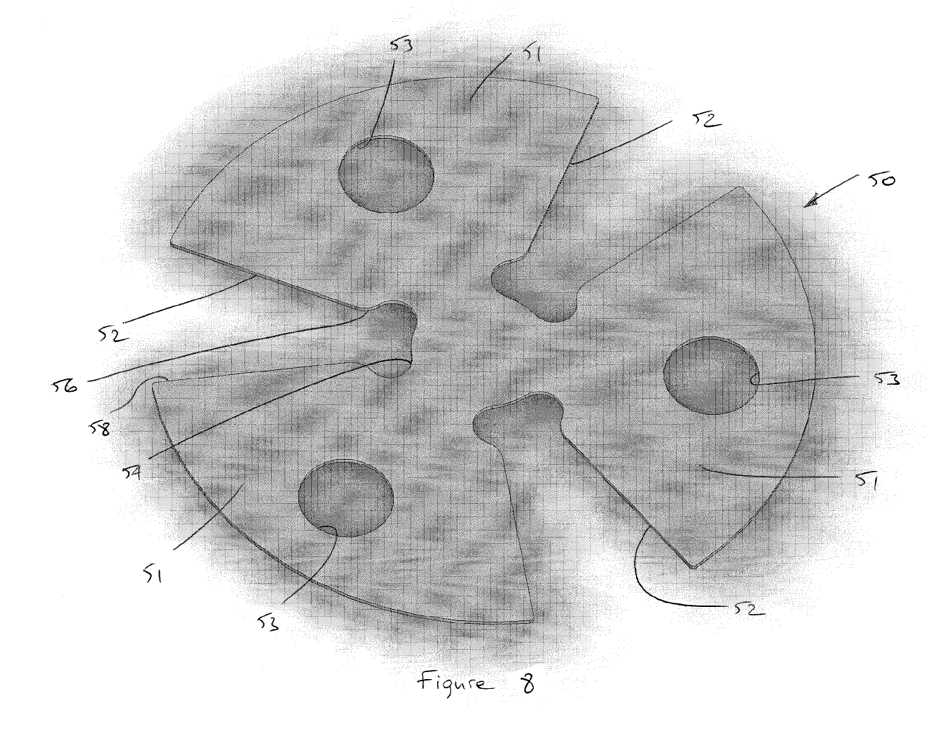

FIG. 7 is a perspective view of a perforated member used in the apparatus;

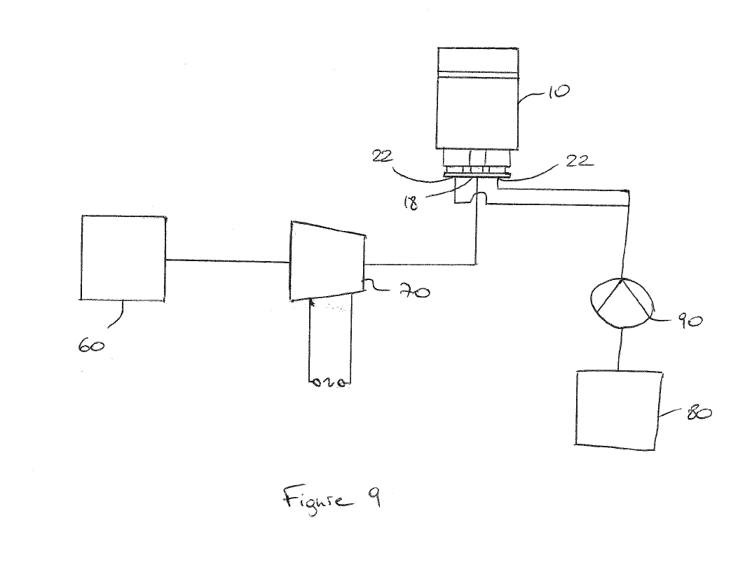

FIG. 8 is a perspective view of a baffle member used in the apparatus; and

FIG. 9 is a schematic view showing a mist generating system incorporating the apparatus of FIGS. 1-6.

FIGS. 1(a) and 1(b) show views of a mist generating apparatus, generally designated 10. The apparatus has a generally cylindrical body made up of a lower body portion 12 and an upper body portion 14 which is removably attached to the lower body portion 12. The lower body portion 12 has a base 16 which includes a number of fluid inlets into which supply connectors may be inserted in order to supply fluids to the apparatus 10. In this preferred embodiment, there is one driving fluid inlet 18 (not shown in FIG. 1) and associated driving fluid supply connector 20 which are co-axial with a longitudinal axis L of the apparatus, and three process fluid inlets 22 (not shown in FIG. 1) and associated process fluid supply connectors 24 circumferentially spaced around the driving fluid inlet 18 and longitudinal axis L. The base 16 also includes three attachment apertures 26 (not shown in FIG. 1) which are circumferentially spaced around the driving fluid inlet 18 and axis L, with the apertures 26 being located between adjacent pairs of the process fluid inlets 22. The apertures 26 receive mechanical attachment components 28, such as bolts or screws, which attach the upper body portion 14 to the lower body portion 12. The lower and upper body portions 12,14 may have substantially the same diameter. That diameter may be about 25-30 mm, and may most preferably be about 28.6 mm. The lower body portion may be about 15-25 mm tall, the upper body portion 14 may be about 5-15 mm tall, and a nozzle gap 100 between the lower and upper body portions 12,14 may be about 0.1-0.5 mm. The total overall height of the apparatus may therefore be about 20.1-40.5 mm. In the illustrated embodiment, the lower body portion 12 is about 19.8 mm tall, whilst the upper body portion 14 is about 10 mm tall. With the preferred nozzle gap 100 between the two body portions 12,14 of about 0.2 mm this gives a total height of the body of about 30 mm.

As can be seen best in FIGS. 3 to 5 the end of the lower body portion 12 remote from its base 16 includes a number of cylindrical guides, or sleeves, 27, each of which projects upwards from the lower body portion 12 and is aligned with a corresponding attachment aperture 26. These guides 27 ensure that each mechanical attachment component 28 is guided into a corresponding threaded recess 13 in the upper body portion 14 so that the two portions 12,14 can be attached to one another. The guides 27 also ensure that other components of the apparatus are correctly positioned and aligned, as will be explained below.

Although not shown in FIG. 1, the supply connectors 20,24 are attached to supply lines which deliver driving and process fluids to the respective inlets 18,22, as will be described in more detail below with reference to FIG. 9.

FIG. 2 shows a sectional view of the apparatus 10 along line A-A shown in FIG. 1(a), which also corresponds with the longitudinal axis L. The lower body portion 12 has a driving fluid passage 30 which is co-axial with axis L and extends through the lower body 12 from the driving fluid inlet 18. Radially offset from the driving fluid passage 30 and axis L are three process fluid passages 32 which are substantially parallel with the driving fluid passage 30 and also extend through the lower body 12 from their respective process fluid inlets 22. The process fluid passages 32 are circumferentially and equidistantly spaced around the central driving fluid passage 30. Each process fluid passage 32 has a smaller diameter than the driving fluid passage 30.

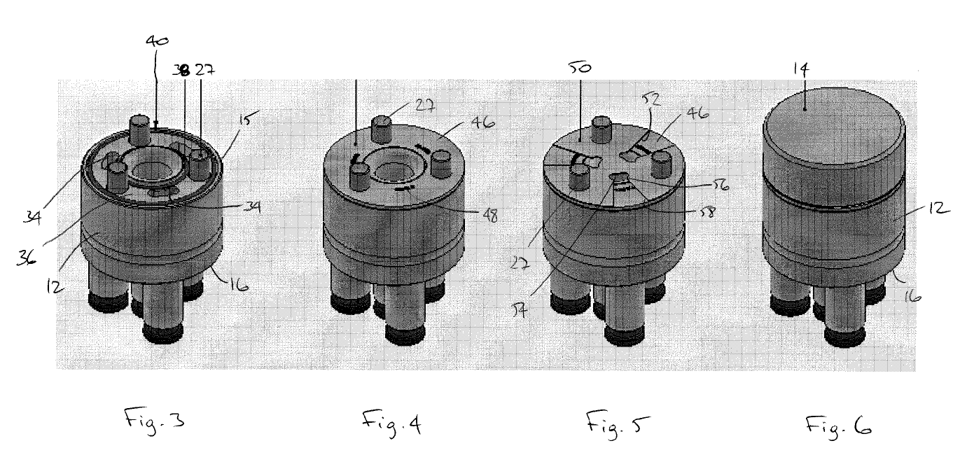

Referring to FIG. 3, each process fluid passage 32 has an outlet 34 at an upper end 15 of the lower body portion 12. The outlets 34 are located in an annular recess 36 within the upper end 15. An inner annular groove 38 is provided in the recess 36 radially inward of the process fluid outlets 34, and an outer annular groove 40 is provided in the recess 36 radially outward of the process fluid outlets 34. Inner and outer O-ring seals 42,44 are located in the annular grooves 38,40. Referring to FIGS. 4 and 7, a perforated member in the form of a perforated member or plate 46 is placed over the recess 36 and the O-ring seals 42,44. The perforated member 46 is provided with a group of small holes 48 in the areas which correspond with the process fluid outlets 34. The holes 48 may be of uniform size, and may be about 0.1-0.5 mm in diameter, and in the illustrated embodiment they each have a diameter of about 0.2 mm. The holes 48 may be provided in the form of a ring which extends around the entire perforated member 46, or else the holes 48 may only be provided in the areas corresponding to the process fluid outlets 34, as is the case in the version shown in the figures. Referring to FIG. 7, the perforated member 46 includes a central aperture 45 which in use aligns with the driving fluid passage 30 so as to not provide any impediment to the flow of driving fluid through the apparatus. The perforated member 46 also includes a number of alignment apertures 47, the number of apertures 47 corresponding with the number of guides 27 extending upwards from the lower body portion 12. When the perforated member 46 is placed on the lower body portion 12 as in FIG. 4, the guides 27 enter the alignment apertures 47 to ensure that the perforated member 46 is correctly positioned on the lower body portion 12. In a preferred embodiment, there are 28 holes in each group of small holes 48. The perforated member 46 may be about 0.5-1.5 mm thick, and is most preferably about 0.80 mm thick.

As best seen in FIGS. 5 and 8, a baffle member or baffle 50 lies upon the perforated member 46. Referring to FIG. 8 in particular the baffle member 50 is a disc from which a number of segments 52 have been cut, leaving baffle sections 51 between each pair of segments 52 which close off a portion of the rotational angle covered by the nozzle. As with the perforated member 46, the baffle member 50 also includes alignment apertures 53 for engagement with the cylindrical guides 27 to ensure the correct positioning of the baffle member 50 on the lower body portion 12 and perforated member 46. In the illustrated embodiment, three segments have been cut from the baffle member 50 and these segments each represent a rotational angle of approximately 30 degrees about the axis L. Each segment 52 is shaped such that when the upper body portion 14 is secured to the lower body portion 12 the segments 52 provide a nozzle inlet 54, nozzle outlet 58 and a nozzle throat 56 intermediate the nozzle inlet 54 and nozzle outlet 58, where the nozzle throat 56 has a cross sectional area which is less than that of both the inlet 54 and outlet 58. When the baffle member 50 is in place, the holes 48 in the perforated member are downstream of each nozzle throat 56. With the upper body 14 secured to the lower body 12 as shown in FIGS. 2 and 6, a nozzle gap 100 defined between the two body portions 12,14 may be 200 μm, which may be defined by the thickness of the baffle member 50.

FIG. 9 shows schematically a mist generating system of which the mist generating apparatus may form part. The system comprises a volume of driving fluid 60 which is fluidly connected to the driving fluid inlet 18 of the apparatus 10 via a mains-powered compressor 70. The system further comprises a volume of process fluid 80 which is fluidly connected to the process fluid inlets 22 of the apparatus 10. The process fluid may be held within a pressurised container. The system may optionally include a pump 90 which pumps the process fluid into the apparatus 10. Although not shown in this basic system drawing, it should be understood that the system may also comprise one or more control valves and associated controller(s) to control the flow of the fluids from their respective supply sources into the apparatus. Such valves and controllers are known in the art and as such will not be described in further detail.

The manner in which the mist generating system and apparatus operate will now be described. In this illustrative embodiment the system and apparatus are to be utilised in a decontamination or cleaning application. The apparatus 10 is firstly positioned at an appropriate location within a room or enclosed space whereby the mist generated by the apparatus may cover the entire room or at least a particular area and/or piece of equipment. The apparatus 10 is then connected to the volumes of driving fluid 60 and process fluid 80 in the manner illustrated in FIG. 9. In this decontamination application, the driving fluid may be a compressed gas, e.g. compressed air, and the process fluid may be water or a decontaminating or cleansing liquid chemical.

Referring to FIGS. 2 and 5, the process fluid flows from its source 80 into the process fluid inlets 22 of the apparatus and from there along the process fluid passages 32. The process fluid exits the passages 32 through outlets 34 and then passes through the holes 48 in the perforated member 46, which creates multiple jets of the process fluid. These jets begin to break up once they enter the nozzle.

At the same time as the process fluid is supplied to the process fluid passages 32 in the apparatus 10, the driving fluid passes from its supply source 60 into the mains-powered compressor 70. The compressed driving fluid then flows from the compressor 70 into the central driving fluid passage 30 of the apparatus 10 via driving fluid inlet 18.

The preferred mass flow ratios between the driving and process fluids are dependent on the particular application for which the apparatus is to be used. For example, in a decontamination application the mass flow ratio between the process fluid and driving fluid is preferably between 1:1 and 2:1. In other words, in the preferred range the mass flow ratio would be 1-2 kg of process fluid for every 1 kg of driving fluid. The flow rate of the driving and process fluids is preferably at least 0.1 kg/min. In a fire suppression application the mass flow ratio between the two fluids is between 2:1 and 8:1, with 2-8 kg of process fluid for every 1 kg of driving fluid.

As the driving fluid reaches the end of the passage 30 it passes into the nozzle inlets 54 defined by the cutaway segments 52 in the baffle member 50. As can be seen best in FIGS. 2 and 5, the reduction in cross sectional area between the nozzle inlet 54 and nozzle throat 56 and subsequent increase in cross sectional area between the throat 56 and nozzle outlet 58 effectively creates three convergent-divergent nozzles within the apparatus. A convergent-divergent nozzle is one which has a throat portion which has a cross sectional area which is less than that of the corresponding inlet and outlet of that nozzle. The variations in cross sectional area from inlet to throat and from throat to outlet are substantially smooth and continuous, with no step changes creating steps or niches in the nozzle walls.

As the driving fluid enters each nozzle segment 52, the reduced cross sectional area of the nozzle throat 56 causes the driving fluid to undergo a significant acceleration. This acceleration causes the velocity of the driving fluid to significantly increase, preferably to at least sonic velocity and most preferably to a supersonic velocity depending on the parameters of the driving fluid supplied to the apparatus. The driving fluid then comes into contact with the jets of process fluid which have entered the nozzle via the holes 48 in the perforated member 46.

As the driving and process fluids come into contact with one another an energy transfer takes place, primarily as a result of mass and momentum transfer between the high velocity driving fluid and the relatively low velocity process fluid. This energy transfer imparts a shearing force on the process fluid jets, leading to atomisation of the process fluid into droplets. This atomisation leads to the formation of a mist made up of a dispersed phase of process fluid droplets in a continuous vapour phase of driving fluid. The mist sprays from the apparatus 10 in the radial direction relative to the axis L, and over the 30 degree rotational angles about axis L which are dictated by the segments 52 in the baffle member 50.

Forcing the process fluid through perforated sections before entering the nozzle allows the apparatus to use lower flow rates without adversely affecting the small droplet sizes obtained by larger, known devices. This means that the apparatus may be used in conjunction with a driving fluid supply that is supplied via a mains-powered compressor rather than a more powerful one which must use a 3-phase power supply. Furthermore, using a baffle member to provide the nozzle segments means that the nozzle gap, and hence nozzle performance, can be adjusted by using a number of interchangeable baffle members of varied thickness. In addition, the number of nozzle segments can also be varied by the interchangeable baffle members.

Although the process fluid passages and associated outlets shown in the preferred embodiment are preferably substantially perpendicular to the radial direction of the nozzle, the or each process fluid outlet may alternatively be at an angle of between 20 and 40 degrees relative to the radial direction of the nozzle.

As discussed above the perforated member or perforated member may provide one or more holes, or one or more slots, adjacent each process fluid outlet. Where slots are provided, they may be straight or curved. The holes or slots may be laser cut. Where one or more holes are provided, they may be angled upstream in the nozzle, in other words against the direction of driving fluid flow through the nozzle.

Whilst the preferred embodiment of the invention is a nozzle which sprays radially over a rotational angle of coverage, the present invention is equally applicable to an axially-extending apparatus. In such a case, the nozzle may be co-axial with the driving fluid passage, and the process fluid outlet(s) containing the perforated member(s) may open into the nozzle perpendicular, or at an oblique angle, to the longitudinal axis of the apparatus.

Whilst the driving fluid used in the preferred embodiment is compressed air, other compressible fluids such as, for example, nitrogen or steam may be used instead. Although the preferred process fluid described above is water, other fluids may be used such as a liquid decontaminant or disinfectant, for example.

The apparatus may have fewer than three process fluid inlets, passages and associated nozzle segments or the apparatus may have more than three. The baffle member should preferably have as many segments as there are process fluid passages in the lower body portion. The apparatus may have at least one process fluid inlet, passage and nozzle segment.

These and other modifications and improvements may be incorporated without departing from the scope of the invention.

1. A mist generating apparatus, comprising:
a nozzle having a nozzle inlet connectable to a source of driving fluid, a nozzle outlet, and a nozzle throat intermediate the nozzle inlet and nozzle outlet, the nozzle throat having a cross sectional area which is less than that of both the nozzle inlet and nozzle outlet;
at least one process fluid passage having an inlet connectable to a source of process fluid and an outlet which opens into the nozzle; and
a perforated member located across the process fluid passage outlet.

2. The apparatus of claim 1, wherein the perforated member comprises a plate located between the or each process fluid passage outlet and the nozzle, the plate having a group of apertures adjacent the or each process fluid passage outlet.

3. The apparatus of claim 1, wherein the perforated member comprises a plate located between the or each process fluid passage outlet and the nozzle, the plate having a plurality of apertures forming a ring around the plate.

4. The apparatus of claim 2, wherein each aperture is circular and has a diameter of about 0.1 to 0.5 mm.

5. The apparatus of claim 1, wherein the perforated member comprises a plate located between the or each process fluid passage outlet and the nozzle, the plate having a single aperture forming a ring around the plate.

6. The apparatus of claim 1, wherein the process fluid passage outlet opens into the nozzle between the nozzle throat and the nozzle outlet.

7. The apparatus claim 1, wherein the nozzle inlet, throat and outlet are substantially co-axial with a longitudinal axis of the apparatus.

8. The apparatus of claim 7, wherein the at least one process fluid outlet opens into the nozzle perpendicular, or at an oblique angle, to the longitudinal axis of the apparatus.

9. The apparatus of claim 1, further comprising:
a body having a longitudinal axis; and
a driving fluid passage having an inlet connectable to the source of driving fluid and an outlet in fluid communication with the nozzle inlet;
wherein the driving fluid passage and at least one process fluid passage extend longitudinally through the body, and wherein the nozzle extends in a substantially radial direction relative to the longitudinal axis.

10. The apparatus of claim 9, wherein the nozzle extends circumferentially about the body such that the nozzle covers a rotational angle about the longitudinal axis.

11. The apparatus of claim 10, further comprising a baffle located in the nozzle, the baffle including one or more sections which close off a portion of the rotational angle covered by the nozzle.

12. The apparatus of claim 11, wherein each pair of adjacent baffle sections defines a baffle opening therebetween, each baffle opening having a baffle inlet, baffle outlet and baffle throat intermediate the baffle inlet and baffle outlet, wherein the baffle throat has a cross sectional area which is smaller than that of both the baffle inlet and baffle outlet.

13. The apparatus of claim 9, wherein the body comprises a first portion in which the driving fluid passage and one or more process fluid passages are located, and a second portion which can be detachably fixed to the first portion, wherein the perforated member lies upon the first portion and defines a first nozzle surface and the second portion has a second nozzle surface such that when the first and second portions are attached the nozzle is defined between the first and second nozzle surfaces.

14. The apparatus of claim 9, wherein the body has a total height of about 25-35 mm and a diameter of about 25-30 mm.

15. A mist generating apparatus, comprising:
a lower body portion including a driving fluid passage having a driving fluid inlet and a driving fluid outlet, and at least one process fluid passage having a process fluid inlet and a process fluid outlet, the driving and process fluid inlets being connectable to respective sources of driving and process fluids;
a first member including a plurality of apertures, the first member lying on top of the lower body portion such that the apertures are located across the process fluid passage outlet;
a second member lying upon the first member and including a plurality of baffle sections which divide the driving fluid outlet into distinct sections; and
an upper body portion which lies upon the second member and is secured to the lower body portion so as to hold the first and second members between the upper and lower body portions;
wherein the first member defines a first nozzle surface and the upper body portion defines a second nozzle surface facing the first nozzle surface, the two nozzle surfaces between them defining at least one nozzle having a nozzle inlet in fluid communication with the driving fluid outlet, a nozzle outlet and a nozzle throat intermediate the nozzle inlet and nozzle outlet, the nozzle throat having a cross sectional area which is less than that of the nozzle inlet and nozzle outlet, and wherein the process fluid outlet opens into the nozzle at or downstream of the nozzle throat.

16. A mist generating system, comprising:
a mist generating apparatus in accordance with claim 1;
a driving fluid source connected to the nozzle inlet for the supply of driving fluid to the nozzle; and
a process fluid source connected to the process fluid passage inlet for the supply of process fluid to the process fluid passage.

17. The system of claim 16, further comprising a compressor located between the driving fluid source and the nozzle inlet.

18. The system of claim 17, wherein the compressor is powered by mains electricity.

19. A method of generating a mist, comprising the steps of:
supplying a driving fluid to a nozzle having a nozzle inlet, a nozzle outlet and a nozzle throat intermediate the nozzle inlet and nozzle outlet, the nozzle throat having a cross sectional area which is less than that of both the nozzle inlet and nozzle outlet;
supplying a process fluid to a process fluid outlet which opens into the nozzle;
passing the process fluid through a perforated member located across the process fluid outlet;
accelerating the driving fluid through the nozzle throat such that the driving fluid applies a shearing force to the process fluid jet having passed through the perforated member, thereby forming a dispersed phase of process fluid droplets in a continuous vapour phase of driving fluid; and
spraying the dispersed process fluid droplets and continuous driving fluid phase from the nozzle outlet.

20. The method of claim 19, wherein the driving fluid is accelerated to sonic or supersonic velocity downstream of the nozzle throat.

21. A method of assembling a mist generating apparatus, the method comprising the steps of:
providing a lower body portion including a driving fluid passage having a driving fluid inlet and a driving fluid outlet, and at least one process fluid passage having a process fluid inlet and a process fluid outlet, the driving and process fluid inlets being connectable to respective sources of driving and process fluids;
placing a first member including a plurality of apertures on top of the lower body portion such that the apertures are located across the process fluid passage outlet;
placing a second member upon the first member, the second member including a plurality of baffle sections which divide the driving fluid outlet into distinct sections; and
placing an upper body portion upon the second member and securing the upper body member to the lower body portion so as to hold the first and second members between the upper and lower body portions;
wherein the first member defines a first nozzle surface and the upper body portion defines a second nozzle surface facing the first nozzle surface, and the two nozzle surfaces between them define at least one nozzle having a nozzle inlet in fluid communication with the driving fluid outlet, a nozzle outlet and a nozzle throat intermediate the nozzle inlet and nozzle outlet, the nozzle throat having a cross sectional area which is less than that of the nozzle inlet and nozzle outlet, and wherein the process fluid outlet opens into the nozzle at or downstream of the nozzle throat.
